(19) United States
(12) Patent Application Publication
(10) Pub. No.: US 2016/0122254 A1
(43) Pub. Date: May 5, 2016

(54) SALT/CLAY MIXTURES AND USES THEREOF

(71) Applicant: Oil-Dri Corporation of America, Chicago, IL (US)

(72) Inventors: Curtis Welborn, Chicago, IL (US); Douglas A. Graham, Chicago, IL (US); John Tornese, Chicago, IL (US); Robert G. Goss, Chicago, IL (US); Chris Frye, Chicago, IL (US)

(21) Appl. No.: 14/930,959

(22) Filed: Nov. 3, 2015

Related U.S. Application Data
(60) Provisional application No. 62/075,050, filed on Nov. 4, 2014.

(51) Int. Cl. C05D 3/00; C09K 17/06; B01J 20/28; C09K 17/08; B01J 20/12; B01J 20/04

(52) U.S. Cl. CPC C05D 3/00; B01J 20/12; B01J 20/046; B01J 20/28011; C09K 17/08; C09K 17/06

(57) ABSTRACT

The present invention relates to a salt and clay mixture which may be involved in melting ice and snow while providing improved traction and uses thereof.

### RELATED APPLICATIONS AND INCORPORATION BY REFERENCE

This application claims benefit of and priority to U.S. provisional patent application Ser. No. 62/075,050 filed Nov. 4, 2014.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FIELD OF THE INVENTION

The present invention relates to a salt and clay mixture which may be involved in melting ice and snow while providing improved traction.

### BACKGROUND OF THE INVENTION

De-icing of roads has traditionally been done with salt, spread by snowplows or dump trucks designed to spread it, often mixed with sand and gravel, on slick roads. Sodium chloride (rock salt) is normally used, as it is inexpensive and readily available in large quantities. However, since salt water still freezes at −18° C. or 0° F., it is of no help when the temperature falls below this point. It also has a strong tendency to cause corrosion: rusting the steel used in most vehicles and the rebar in concrete bridges. More recent snowmelters use other salts, such as calcium chloride and magnesium chloride, which not only depress the freezing point of water to a much lower temperature, but also produce an exothermic reaction. They are somewhat safer for concrete sidewalks, but excess should still be removed.

More recently, organic compounds have been developed that reduce the environmental issues connected with salts and have longer residual effects when spread on roadways, usually in conjunction with salt brines or solids. These compounds are generated as byproducts of agricultural operations such as sugar beet refining or the distillation process that produces ethanol. Additionally, mixing common rock salt with some of the organic compounds and magnesium chloride results in spreadable materials that are both effective to much colder temperatures (−30° F./−34° C.) as well as at lower overall rates of spreading per unit area.

The use of liquid chemical melters has been increasing, sprayed on roads by nozzles instead of a spinning spreader used with salts. Liquid melters are more effective at preventing the ice from bonding to the surface than melting through existing ice.

Several proprietary products incorporate anti-icing chemicals into the pavement. Verglimit® incorporates calcium chloride granules into asphalt pavement. The granules are continually exposed by traffic wear, and release calcium chloride onto the surface. This prevents snow and ice from sticking to the pavement. Cargill SafeLane® is a proprietary pavement surface treatment that absorbs anti-icing brines, to be released during a storm or other icing event. It also provides a high-friction surface, increasing traction.

Citation or identification of any document in this application is not an admission that such document is available as prior art to the present invention.

### SUMMARY OF THE INVENTION

There remains a need for improved products for de-icing as well as providing traction.

The present invention relates to a dry composition which may comprise, consist essentially of or consist of a mixture of clay and salt. Advantageously, the mixture may be about 50% (by weight) clay and about 50% (by weight) salt.

The clay may be a low moisture content clay. The clay may be a montmorillonite clay. In an advantageous embodiment, the clay may be an low volatile material (LVM) product, such as a Pro's Choice® Red product. In some embodiments, the clay may be a brine impregnated clay, which may be an 80:20 clay:salt solution.

The salt may be NaCl, CaCl₂, MgCl₂, K₂SO₄ and/or a mixture thereof. Advantageously, the salt is NaCl.

The present invention also encompasses methods of manufacturing the dry salt/clay compositions disclosed herein which may comprise mixing the clay and the salt to form a mixture and drying the mixture, thereby manufacturing the dry composition of any of the compositions disclosed herein.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 depicts an overview of a test area after a very light snowfall.

FIG. 2 depicts that 100% clay had no measurable ice melting but did slightly improve traction.

FIG. 3 depicts that with 75% clay/25% CaCl₂ the ice melted just a little with the salt that was added. The clay improved the traction and absorbed almost all of the water produced.

FIG. 4 depicts that with 50% clay/50% CaCl₂ a large portion of the ice melted and the clay absorbed a significant portion of the water, leaving little water available for refreeze. The clay and significant amount of ice melting gave good traction on this patch.

FIG. 5 depicts that with 25% clay/75% CaCl₂ the ice melted quite well but only in spots right where the salt was. The clay only slightly improved traction and was saturated quickly with water, leaving water available for refreeze.

FIG. 6 depicts that with 100% CaCl₂ the salt quickly melted most of the ice but the free water spread underneath the rest of the patch. This made the patch break apart when stepped on, so inadvertently created better traction, but water remained available for refreeze.

FIG. 7 depicts that with spray-on CaCl₂ the coated clay had enough salt on itself to embed itself in the ice and absorb the water that it created. However it did not have enough salt to melt very much ice. The traction was improved with the clay embedded in the ice. In comparison to the pour-on method below, there was a very even distribution of effective clay particles.

FIG. 8 depicts that with pour-on CaCl₂. Some of the coated clay embedded in the ice and absorbed the water it created. The rest of the clay stayed dry and rested on top of the ice, likely due to a failure to have received a CaCl₂ coating. The traction was improved with the clay. In comparison to the spray-on method, the distribution of coated clay was not even.

FIG. 9 depicts that soaked CaCl₂ had the same result as the spray-on CaCl₂ clay. The clay embedded into the ice and absorbed the water produced. Also the traction was improved with the clay embedded into the ice.

FIG. 10 depicts an experimental traction test, a flat 22 inch by 5 inch piece of ice was prepared for traction testing. A sample of each material (10 mL) was sprinkled over the surface of the ice. The ice was then placed at a 20 degree angle. A hockey puck (163 g, 2.8 inch diameter) was placed on the top of the incline and released. The time to reach the bottom of the incline was recorded. The longer the puck took to reach the bottom of the slope the greater the traction.

FIG. 11 depicts an experimental plant growth test. Three samples were prepared, control of only soil, a 10% by volume sample of EcoTraction™ in soil and a 10% by volume sample of Pro's Choice Red® in soil. 500 mL of soil were placed in containers with 25 grams of “cat grass” seed placed ½ deep in the soil. Samples were watered with 50 mL every other day for two weeks. The samples were then removed and measured for growth length.

FIG. 12 depicts sorption by the Van Trump method.

FIG. 13 depicts photographs of the two samples used in the study. Sample 1 was 5/20 LVM-MS red and sample 2 was glass beads used as a non-porous reference sample.

FIG. 14 depicts an experimental set up for heat of water adsorption measurement. (1) Insulated glass bottle containing clay or glass beads; (2) and (3) thermocouple probes; (4) and (5) temperature read outs.

FIG. 15 depicts a plot of sample temperature vs amount of water.

### DETAILED DESCRIPTION OF THE INVENTION

The salt/clay blend of the present invention is advantageous for several reasons. The blend reduces/mitigates normal spalling of concrete caused by salt alone. The blend is more environmentally friendly because clay improves soil quality while salt damages soil and vegetation. Clay heats up when exposed to water and the darker color of clay absorbs sunlight, providing additional melting of ice. Clay provides some traction aid while salt does not. The clay carrier is not as susceptible to large clumping or turning into single solid when exposed to humidity in packaging as packages of pure salt and because the clay absorbs available moisture, less clumping occurs with the salt as well. The blend causes less internal damage to flooring in homes when tracked in because it is softer than quartz sand or limestone and contains less corrosive salt.

A purpose of the blend of the present invention is not only to melt the ice and snow but also to provide better traction. The absorbent constituent that was chosen to help accomplish this task was a Fullers Earth Clay that had been heat treated sufficiently to prevent slaking. Other absorbing materials for water-based liquids will also work. The term “absorbent constituent” refers to absorbent mineral and non-mineral materials. For example, suitable mineral material can be, but is not limited to, montmorillonite, attapulgite, expanded shale, diatomaceous earth, diatomite, antelope shale, absorbent gypsum, bentonite, vermiculite, perlite, silica gel, smectite, and sepiolite, or mixtures thereof. In other embodiments of the invention, suitable non-clay or non-mineral absorbent materials are contemplated. These non-mineral materials can be, but are not limited to, walnut shells, bark, wood chips, and whole or broken corn substrate (including kernels and corncob). A key attribute of a preferred embodiment is very low moisture content, which provides the ability to absorb a good amount of water that is created with the melting ice and snow. The preliminary experimentation included the use of plain table salt and the clay. The original idea was to bind the salt to the clay as well as use raw salt in a mixture to accomplish the desired task. In an advantageous embodiment, the absorbent constituent may comprise non-swelling bentonite, which is primarily composed of calcium montmorillonite and opal mineral phases along with minor amounts of quartz, illite and feldspar minerals.

Although Pro's Choice® Red (a LVM clay granule, more specifically a 5/20 mesh LVM-MS material derived from a Ca-Bentonite clay (i.e., primarily Ca-Montmorillonite) raw material) is preferred for the present invention, other Pro's Choice® clays which may be contemplated for the present invention include, but are not limited to, low moisture LVM calcium bentonite/montmorillonite clays, such as Pro's Choice® Red infield conditioner, Pro's Choice® Select infield conditioner, Pro's Choice® Pro Mound, Pro's Choice® Rapid Dry drying agent and Pro's Choice® Pro Red premium topdressing. Other suitable materials which do not slake are also contemplated, such as Fullers Earth.

The absorbent constituent of the present invention may also be extrapolated to other clays with a low moisture content. In an advantageous embodiment, the clay constituent is montmorillonite clay. The smectite family of clays includes the various mineral species montmorillonite (in particular a bentonite-montmorillonite clay), nontronite, hectorite and saponite, all of which can be present in the clay mineral in varying amounts. These clays may range in color from a cream or grey off-white to a dark reddish tan color. These clays may also contain calcium and/or magnesium in the form of exchangeable cations. Other preferred clays may include an attapulgite/palygorskite clay or an opalaceous material/opaline silica clay.

The clay constituent of the present compositions may be in the form of discrete particles. These particles may be angular. Although particle sizes up to about 1 inch are suitable, a preferred size of clay particles may be in the range of about 4 by about 60 mesh, U.S. Sieve Series. For a tabulation of U.S. Sieve Series screen nomenclature, see Perry's Chemical Engineering Handbook, 6th Ed., McGraw-Hill, Inc., New York, N.Y. (1984), p 21-15 (table 21-6). An especially preferred size range for the clay particles in the present invention may be in the range of about 20 to about 4 mesh. An embodiment of the bulk density ranges from about 15 to 90 lb/ft³. A preferred range for the bulk density in the present invention would be 25-45 lb/ft³.

The absorbent constituent of the present invention may be prepared according to several different procedures depending upon each clay source. It is an embodiment of the present invention to heat-treat the absorbent constituent prior to blending with salt to prevent slaking and to increase absorbency. Each clay source dictates the different temperatures need to achieve a non-slaking property. The clays are generally heat-treated to at least 600° F. and more preferably at least 900° F. in a rotary kiln; the temperature being the measured discharge temperature of the kiln. The clays are heat-treated generally between 15 and 45 minutes, depending on the type of kiln.

It is an embodiment of the invention to heat the clay to a temperature which removes the water but maintains porosity. Generally, the point at which porosity is greatly diminished is at approximately 1,800° F. for clays such as attapulgite and approximately 2500° F. for clays such as montmorillonite.

It is an aspect of the invention to maximize the amount of liquid the clay can hold and remain free-flowing. In general, the liquid holding capacity (LHC) of the clay constituent is at least 10% when the liquid is water. For a standard method of determining liquid holding capacity in granules such as clays, zeolites, and various inorganic and organic solids which are insoluble in kerosene, see ASTM Standard Test Method E1521-93, Liquid Holding Capacity (LHC) of Clay Granular Carriers.

It is also an aspect of the invention where the absorbent constituent provides traction. Traction is provided by improving the interaction forces exerted on the contact surfaces. For example, the absorbent constituent absorbs liquid while still maintaining structural integrity and providing traction much like traction elements on a tire, especially in slippery conditions. In an advantageous embodiment, the absorbent may be irregularly shaped to improve traction.

The present invention relates to a dry composition for absorbing water created by ice melting comprising an absorbent constituent and a salt wherein the proportion amount ranges from about 90:10 wt % to about 10:90 wt %, wherein the absorbent constituent is heat-treated to prevent slaking. In another embodiment, the proportion amount ranges for the absorbent constituent and salt from about 75:25 wt % to about 25:75 wt %. In a further embodiment, the proportion amount ranges for the absorbent constituent and salt from about 60:40 wt % to about 40:60 wt %.

In another embodiment, the dry composition comprises an absorbent constituent which has a liquid holding capacity of at least 10%.

In an embodiment of the dry composition, the absorbent constituent is a non-mineral absorbent material. These non-mineral materials can be, but are not limited to, walnut shells, peanut hulls, oat hulls, wood chips or shavings, poultry litter, barley grains, what grains, coffee beans, rice grains, chicken starter (feed for baby chicks), whole or broken corn substrate (including kernels and corncob), pine fibers, or mixtures thereof.

In another embodiment, the absorbent constituent of the dry composition is a low moisture content clay. In a further embodiment, the low-moisture content clay can be, but is not limited to, montmorillonite, attapulgite/palygorskite, expanded shale, diatomaceous earth, diatomite, antelope shale, absorbent gypsum, bentonite, vermiculite, perlite, silica gel, smectite, and sepiolite, or mixtures thereof. In other aspects of the invention, heat-treatment is utilized to prevent slaking of the material.

In an embodiment, the absorbent constituent of the dry composition changes to a darker color upon absorption of a liquid. In another embodiment, the absorbent constituent generates heat through the adsorption of a liquid. In another embodiment, darker materials are selected to allow for greater sunlight heating. In a further embodiment, the absorbent constituent provides traction.

In an embodiment of the invention, the absorbent constituent and the salt both have a particle size in the range from 60 mesh to 4 mesh. In a further embodiment, the particle size of both the absorbent constituent and the salt ranges from 20 mesh to 4 mesh. In another embodiment, the absorbent constituent and the salt have a bulk density in the range from 15-90 lb/ft³.

In an embodiment, the dry composition comprises an absorbent constituent which is a brine impregnated clay. In a further embodiment, the brine impregnated clay is an 80:20 clay-to-salt solution.

In an embodiment, the dry composition comprises a salt which is NaCl, CaCl₂, MgCl₂, K₂SO₄ or a mixture thereof. In a further embodiment, the salt is NaCl.

The present application relates to a method of manufacturing the dry composition comprising mixing an absorbent constituent and a salt to form a mixture and drying the mixture, thereby manufacturing the dry composition according to the present application.

Any salt is contemplated for the present invention. Preferred salts are rock salt or halite, the mineral form of NaCl. Other salts that are advantageous include, but are not limited to, chloride salts and sulfate salts such as, for example, NaCl, CaCl₂, MgCl₂ and K₂SO₄ and mixtures thereof. Common salt-forming cations include, but are not limited to, Ammonium NH₄⁺, Calcium Ca²⁺, Iron Fe²⁺ and Fe³⁺, Magnesium Mg²⁺, Potassium K⁺, Pyridinium C₅H₅NH⁺, Quaternary ammonium NR₄⁺ and Sodium Nat Common salt-forming anions (with parent acids in parentheses) include, but are not limited to, Acetate CH₃COO⁻ (acetic acid), Carbonate CO₃²⁻ (carbonic acid), Chloride Cl³¹ (hydrochloric acid), Citrate HOC(COO⁻)(CH₂COO⁻)₂ (citric acid), Cyanide C≡N⁻ (hydrocyanic acid), Fluoride F⁻ (hydrofluoric acid), Nitrate NO₃⁻ (nitric acid), Nitrite NO₂⁻ (nitrous acid), Phosphate PO₄³⁻ (phosphoric acid) and Sulfate SO₄²⁻ (sulfuric acid).

Road salt is also contemplated for the present invention. For de-icing, mixtures of brine and salt are used, sometimes with additional agents such as CaCl₂ and MgCl₂. The use of salt or brine becomes ineffective below −10° C. (14° F.). Other additives may be used in road salt to reduce the total costs. For example, a byproduct carbohydrate solution from sugar beet processing may be mixed with rock salt.

The salt constituent of the present composition is contemplated to be a particle size which is similar to the particle size of the clay constituent. An embodiment of the particle size for the salt ranges from about 250 microns to 6,300 microns. In another embodiment, the particle size ranges from 250 microns to 841 microns. Similarly, the bulk density of the salt constituent should also match the density of the clay constituent which ranges from 15 to 90 lbs/ft³. The contemplated particle size for the salt and clay constituents is selected to minimize segregation of the salt and the clay following manufacturing.

Several different salts that are currently available were used in conjunction with the clay of the present invention, which include, but are not limited to, CaCl₂ encapsulated in liquid Mg, (a blend of MgCl₂ and K₂SO₄), MgCl₂ and table salt.

A preferred embodiment may be a 50/50% wt. dry mixture of any of the salts and the Pro's Choice® Red which was effective in melting and increasing traction and increased the amount of traction on ice.

The process whereby a brine solution is used to adhere salt to the clay marginally increased the effectiveness of the melting.

Below are the two formulae that are recommended for combinations of salt and clay. Rock salt is advantageous because of its availability and price. The use of other salt products are also contemplated using the same formulae.

Formula 1.

| Ingredient | % wt. |
|---|---|
| Brine Impregnated | 50 |
| Clay | |
| Rock Salt (4/20 | 50 |
| mesh) | |

The brine impregnated clay was prepared by spraying a 25% wt. rock salt solution onto Pro's Choice® Red in a weight ratio of 80:20 clay:salt solution. Other contemplated ratios of brine impregnated clay include about 5-25% rock salt solution and a ratio of 90:10 to 66:34 clay:salt solution. Brine solution concentrations beyond the upper limit do not adhere to the clay constituent.

Then mix the brine impregnated clay with the Rock salt at a weight ratio of 50:50. Package undried.

Formula 2.

| Ingredient | % wt. |
|---|---|
| Pro's Choice ® Red | 50 |
| Rock Salt (4/20 | 50 |
| mesh) | |

Mix the two dry ingredients at a weight ratio of 50:50 and package.

A salt solution was prepared using 75.0 g of table salt and 250 mL of water. This was mixed until all of the salt was dissolved. This was then transferred to a spray bottle. The salt solution was sprayed onto 550 g of Pro's Choice® Red clay and while the clay was still visibly moist, 300 g of Table salt was added and all of this was mixed together. This mixture was allowed to dry overnight in the open air. This mixture was spread onto a section of ice that was about ⅛-¼″ thick made in a freezer. The sample was placed back into the freezer with the mixture of clay and salt on it. After an hour, this was observed to see the effectiveness of the mixture.

For dry blends, the Pro's Choice® Red was mixed in different ratios with the Roadrunner ice melter, per the below table. Dry Blends were all tested on a small scale. This small scale test was done in petri dishes. 30 mL of water was frozen in a petri dish for each of the samples listed above. Then the clay/salt mixture was added and they were observed for 20 minutes to see the effectiveness of each of the ratios. This same observation procedure was done for some other samples that were prepared as well. This was to replicate the preliminary experimentation that had the salt being bound to the clay. The different methods of producing this are as follows.

| % Clay | % Salt |
|---|---|
| 100 | 0 |
| 75 | 25 |
| 50 | 50 |
| 25 | 75 |
| 0 | 100 |

Pour-on CaCl₂ was made by creating 1L of a saturated solution of the Roadrunner CaCl₂ salt. With 2000 g of clay evenly distributed on a baking sheet all of this saturated solution was poured evenly over the top. It was then mixed by hand to distribute the solution throughout the clay. This mixture was dried in a conveyor style pizza oven at 350° F. at a 6 minute setting on the timer twice with some mixing of the sample in between. At the end there were some large pieces of crystalline salt that were not bound to clay on the bottom of the baking sheet. This was most likely due to the crystallization of any free moisture on the baking sheet. Since the solution was poured over the top of the clay it is possible that the clay was unable to absorb all of the solution.

Spray-on CaCl₂ was made by starting with 1 L of a saturated solution of the Roadrunner CaCl₂ salt. Using 2000 g of clay that was placed in a large pan, all of the solution was sprayed over the clay and mixed by hand. While spraying the solution onto the clay a few seconds in between sprays was taken to allow the clay to adsorb the solution. Next the mixture was dried in our conveyor style pizza oven at 350° F. at a 6 minute setting on the timer twice with some mixing of the sample in between. The goal of this method was to maximize the amount of salt that was bound to the clay. Less particles of just salt were found on the bottom of the baking sheet indicating that more was bound to the clay. The smaller amount of crystalline salt on the bottom of the baking sheet was due to the slower addition of the solution to the clay and allowing it to absorb into the clay more effectively.

Soaked CaCl₂ was made with 500 mL saturated solution of CaCl₂ in a 1000 mL beaker. Next 100 g of the Pro's Choice® Red was added into the saturated solution. This soaked in the solution for 4 hours. It was then dried at 105° C. overnight to remove the water. This was in an attempt to have a visible presence of the salt bound to the clay.

Field Trial with CaCl₂ and Clay mixtures. The next part of the testing was to create a large patch of ice outside and try all of these creations in real life scenario. The patch of ice was created by first rinsing off a patch of blacktop with a hose to remove the current salt residue from previous salting. Once all of the residual salt was washed away the hose was used to slowly spray the blacktop until approximately ⅛-¼ inch of ice was formed. The patch was left to solidify overnight. The next morning nine different 1-square yard portions of the ice were sectioned off. An 85 g portion of each prepared sample was spread evenly in each corresponding section. The 85 g sq. yd. is from the recommended use of the salt on ice. Throughout the day, the sections were observed periodically. In the afternoon, there was some light snow that fell which helped show which samples were working the best.

Various Types of Ice Melting Salt. During the original testing procedure, the local weather played a factor in sourcing many types of in melting salts. Based on the results that were collected from the above experimentation a basic test has been done utilizing the different salt types. A 50/50 dry mix of each of Pro's Choice® Red and the other salt types; Rock Salt, MgCl₂, & MgCl₂ with K₂SO₄, were produced to do some testing. Using a large pan a portion of 500 mL of water was added, one pan for each mixture. The three pans were then left outside to freeze and create a ⅛-¼ inch thick piece of ice. Then calculating to have the same g/sq. yd. coverage as the previous test, 11 g of each was added to the pans of ice. These were observed throughout a day to see the effectiveness of the different types of salt in conjunction with the clay.

Size Analysis and Bulk Density. The standard test procedures for Particle Size, SGN, UI and Bulk density were used to determine the results that follow in the results section of this report. The STP numbers for these tests are as follows; PS 001.01.01, PS 006.01.01, DN 001.01.01.

Replicate of Original method. The repeat of the original method of testing showed the following results. The small table salt particles embedded in the ice did not melt anything. The coated clay slightly embedded into the ice improving traction but all of the ice remained without being melted. The small table salt particles had a hard time sticking to the larger clay particles and even distribution of clay and salt was hard to achieve.

Small Scale Testing. The testing on the small scale with the petri dishes was all qualitative. The 100% clay sample did not actively melt any of the ice, however as the ice melted naturally the clay began to adsorb the water. The 100% Roadrunner salt sample shows how effective the CaCl₂ is at melting ice. It quickly burrowed a hole through the ice in the place it was and melted the ice quickly. The dry mixtures of the salt and clay showed how well the two can work together. In all cases the salt melted the ice quickly and the clay adsorbed the water. The 50/50 mixture seemed to be the best balance between melting ability and moisture adsorption. Also the 50/50 mixture seemed to have enough clay to improve traction as opposed to the 25% Clay sample seeming to have not enough. Also in regards to the salt the sample with 50% Salt seemed to be about the correct amount while the sample with only 25% Salt was not quite enough to melt a good portion of the ice.

Field Trial with CaCl₂ and Clay mixtures. Determining that a 50/50 blend of the two products, clay & salt, was the most effective with the least amount of work, that is what was tested with the other salt products. The results were pretty much the same as that of the 50/50 blend with CaCl₂ except with the rock salt. Both the MgCl₂ and MgCl₂/K₂SO₄ blends worked just as well as the CaCl₂ blend, with good ice melting and good traction. In the case of the rock salt, the particle size of the rock salt was so much greater that it did not spread as well. This created little burrowed holes where the salt was and the clay could only absorb so much. This was due to the proximity of the clay to the burrowed holes. If the clay was right next to the hole it absorbed the water. Conversely, if clay was not near the burrowed hole then it was unable to absorb the water created from the melting ice. The dry clay would sit upon the ice with no added effect other than adding surface traction.

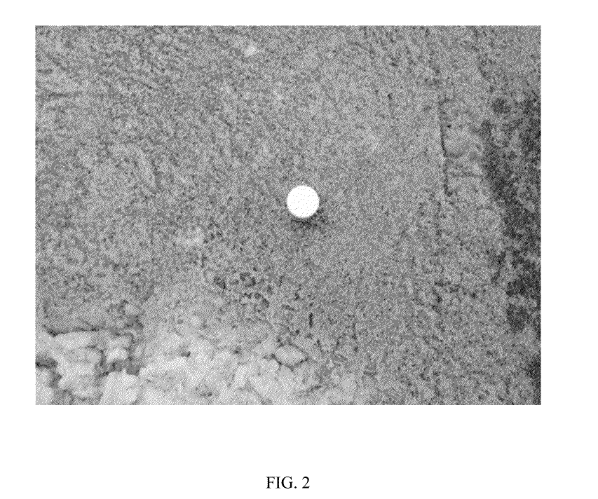

For the field trial testing everything was again all qualitative. The pictures depicted in FIGS. 2-9 are of all the samples that were tested on the large patch of ice. The traction improvement is stated with each figure.

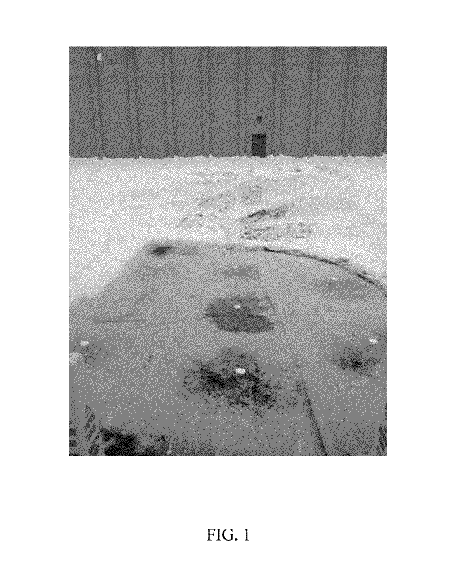

FIG. 1 depicts an overview of a test area after a very light snowfall.

FIG. 2 depicts that 100% clay had no ice melting property but did slightly improve traction.

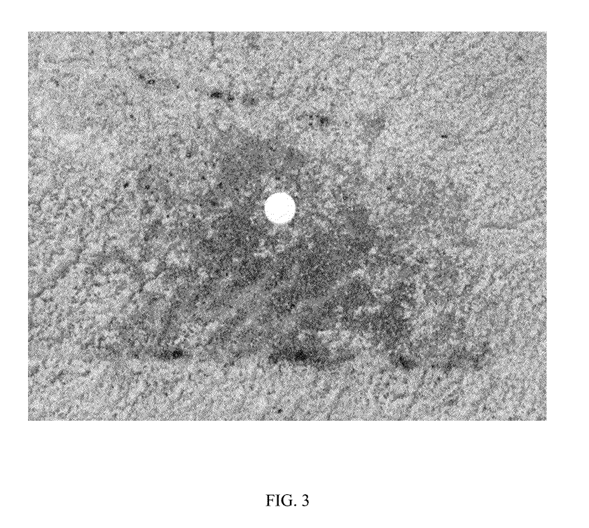

FIG. 3 depicts that with 75% clay/25% CaCl₂ the ice melted just a little with the salt that was added. The clay improved the traction and absorbed almost all the water produced.

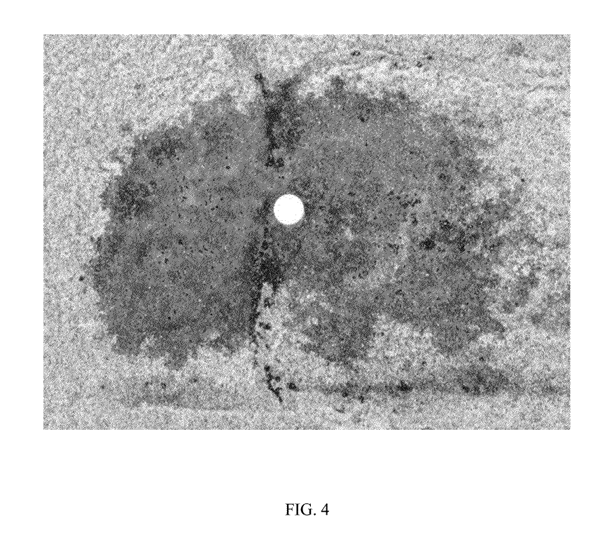

FIG. 4 depicts that with 50% clay/50% CaCl₂ a large portion of the ice melted and the clay absorbed a good portion of the water. The clay and good amount of ice melting gave good traction on this patch.

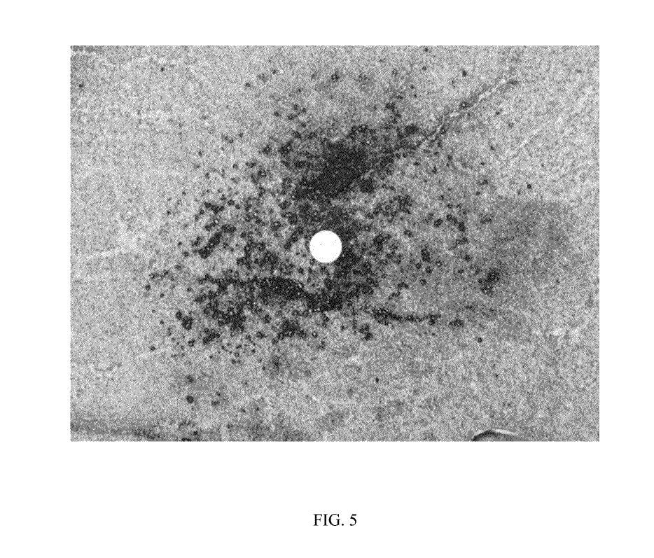

FIG. 5 depicts that with 25% clay/75%CaCl₂ the ice melted quite well but only in spots right where the salt was. The clay only slightly improved traction and was saturated quickly with water.

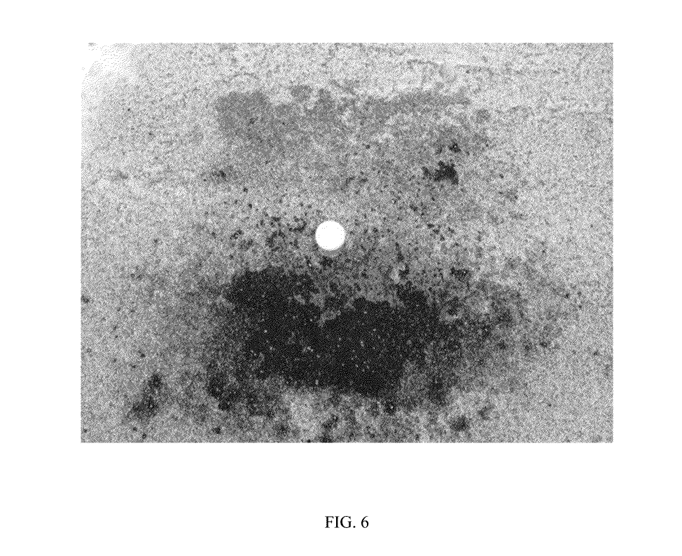

FIG. 6 depicts that with 100% CaCl₂ the salt quickly got rid of most of the ice and the free water spread underneath the rest of the patch. This made the patch break apart when stepped on, so inadvertently created better traction.

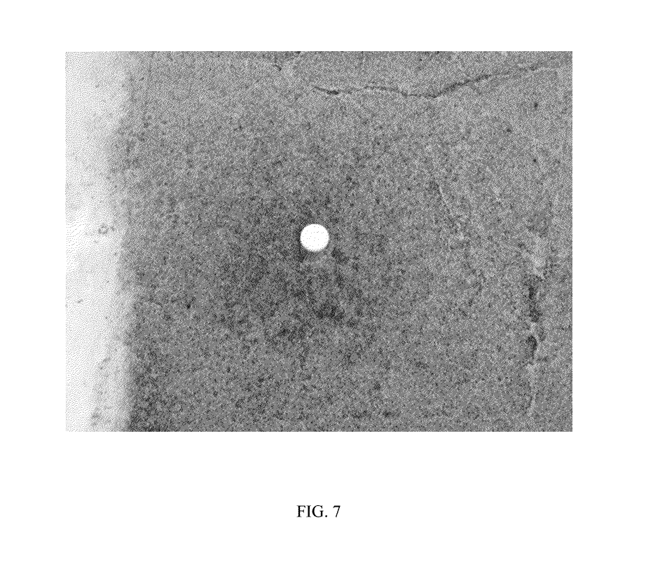

FIG. 7 depicts that with spray-on CaCl₂ the coated clay had enough salt on itself to embed itself in the ice and absorb the water it created. However it did not have enough salt to really melt very much ice. The traction was improved with the clay embedded in the ice. In comparison to the pour-on method below; this was a very even distribution of effective clay particles.

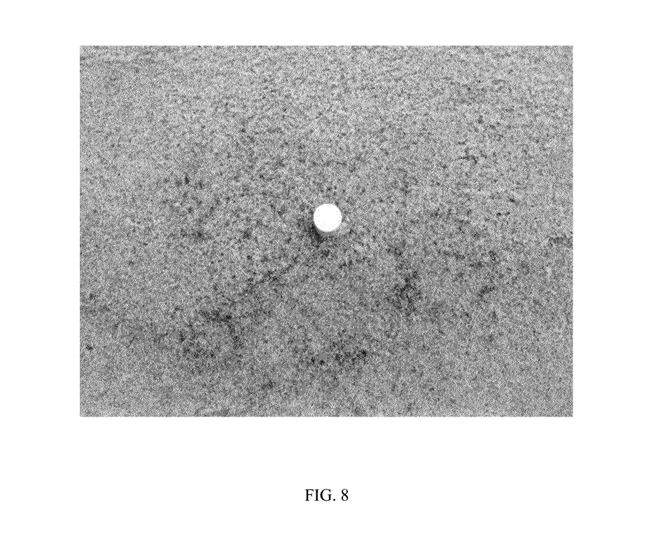

FIG. 8 depicts that with pour-on CaCl₂ some of the coated clay embedded in the ice and absorbed the water it created. The rest of the clay must not have gotten any salt on it because it stayed dry and rest on top of the ice. The traction was improved with the clay. In comparison to the spray-on method the distribution of coated clay was not even.

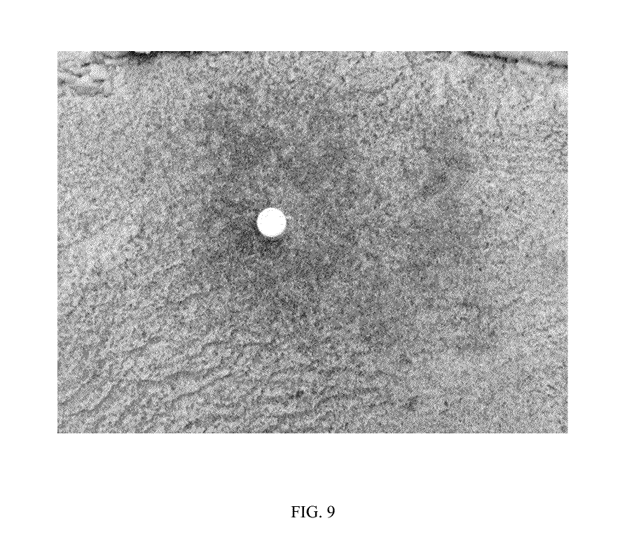

FIG. 9 depicts that soaked CaCl₂ had the same result as the spray-on CaCl₂ clay. The clay embedded into the ice and absorbed the water produced. Also the traction was improved with the clay embedded into the ice.

Physical tests and laboratory analysis also compares Pro's Choice® Red to EcoTraction™. Pro's Choice® Red is a larger, harder material (near 10×lower slaking meaning easier to clean up) with a smaller particle distribution range and less free moisture than EcoTraction™. It also is 36% lighter (based on density) which makes it easy to lift, carry and pour. Although Applicants' total water absorption is 25% less than EcoTraction™, Applicants' liquid holding capacity for water is nearly twice as high. EcoTraction™ claims that its material, if mixed with soil at a 10% volume, “improves soil aeration as well as moisture and nutrient retention.” Both Pro's Choice® Red and EcoTraction™ outperformed the control. The plants grew faster and bigger with the addition of a 10% by volume sample in soil. The below table provides a summary of the physical properties of the above-discussed materials.

| | EcoTraction ™ | Pro's Choice Red ® |
|---|---|---|
| Liquid Holding | 12.9% | 21.1% |
| Capacity-Water | by volume | by volume |
| Absorption, | 49.9% | 37.4% |
| Water-GSA | by volume | by volume |
| Free Moisture | 13.54% | 1.02% |
| (wt. %) | | |
| Hardness | 75.5% | 93.9% |
| (%)-Resistance | | |
| to Attrition | | |
| Slaking Test | 18.6% | 2.0% |
| Bulk | 53.87 lb/ft \hat{ }3 | 34.44 lb/ft \hat{ }3 |
| Density-Loose, | | |
| Ohaus | | |
| Absorption, | 39.6% | 25.3% |
| Water-Van | by volume | by volume |
| Trump Method | | |
| Sorbent Sorption | | |
| Ratio | | |
| Experimental | 3 trials = 6 secs | 3.2 secs |
| Traction | 3 trials = stopped | |
| Test | before the bottom | |
| MultiPoint BET | 63.8 m²/g | 101.7 m²/g |
| (surface area) | | |
| DFT Method | 0.14 cc/g | 0.28 cc/g |
| Cumulative pore | | |
| Volume | | |

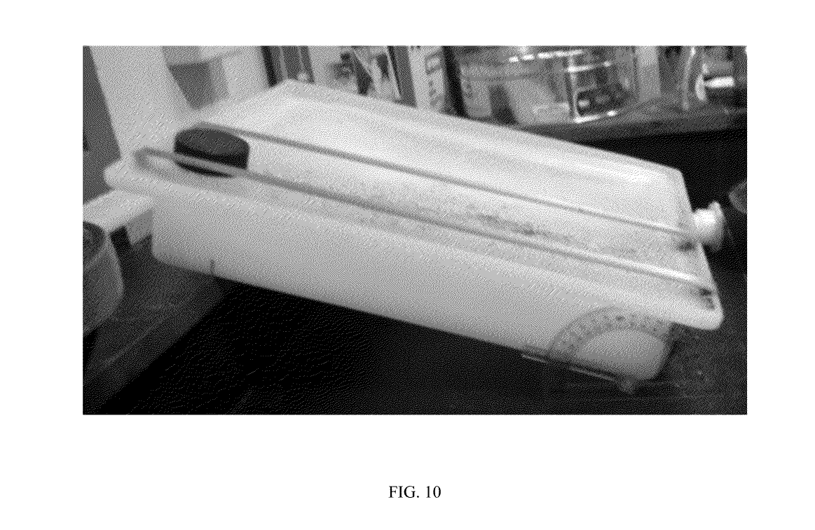

FIG. 10 depicts an experimental traction test, a flat 22 inch by 5 inch piece of ice was prepared for traction testing. A sample of each material (10 mL) was sprinkled over the surface of the ice. The ice was then placed at a 20 degree angle. A hockey puck (163 g, 2.8 inch diameter) was placed on the top of the incline and released. The time to reach the bottom of the incline was recorded. The longer the puck took to reach the bottom of the slope the greater the traction.

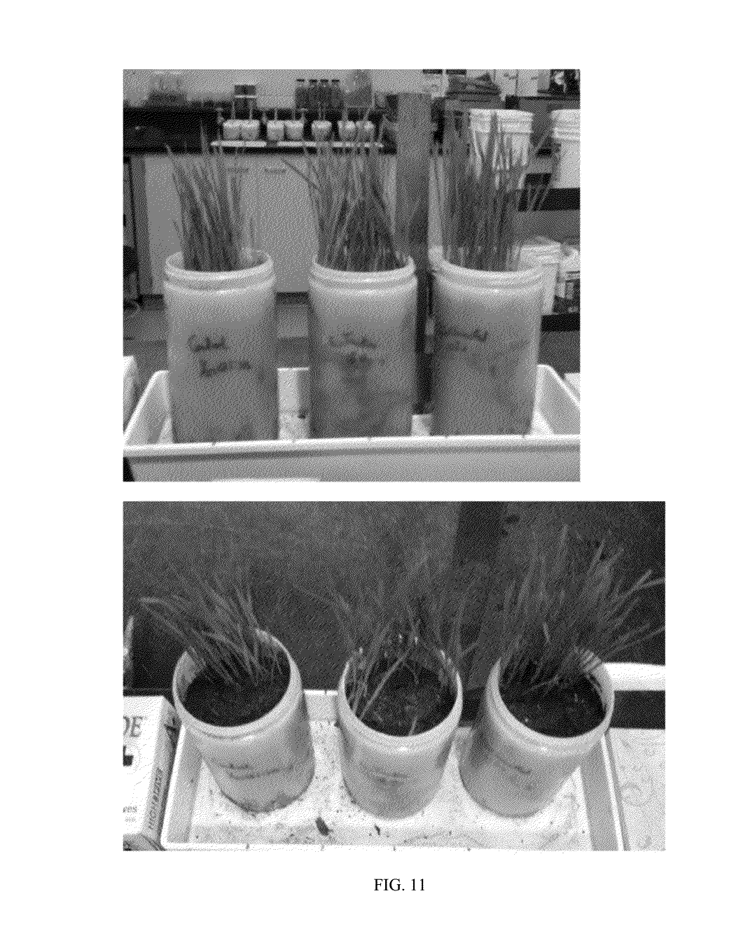

In an experimental plant growth test, three samples were prepared, control of only soil, a 10% by volume sample of EcoTraction™ in soil and a 10% by volume sample of Pro's Choice Red® in soil. 500 mL of soil were placed in containers with 25 grams of “cat grass” seed placed ½ deep in the soil. Samples were watered with 50 mL every other day for two weeks. The samples were then removed and measured for growth length. The results are presented in FIG. 11 and in the below table

| | Control | EcoTraction ™ | Pro's Choice Red ® |
|---|---|---|---|
| Above ground | 8.5″ | 9.5″ | 9.5″ |
| growth | | | |
| Below ground | 8.5″ | 9.0″ | 9.1″ |
| growth | | | |

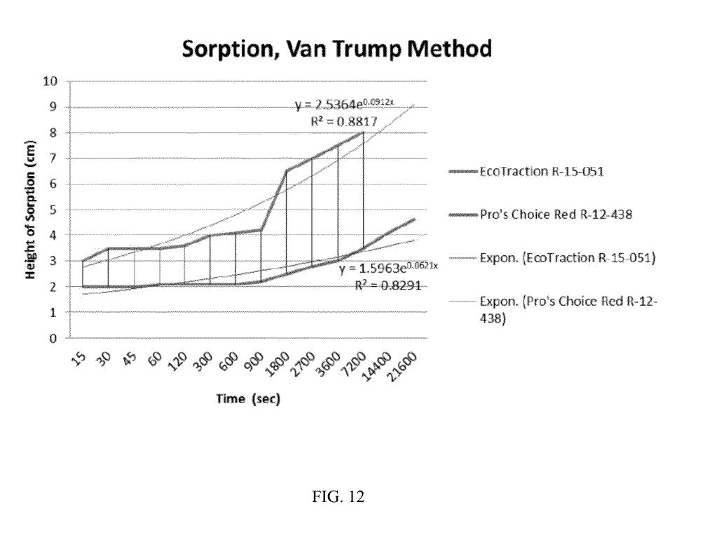

FIG. 12 depicts sorption by the Van Trump method. The Van Trump method is used to determine the rate at which water or oil is absorbed by a granular material and transported vertically upward by capillary action. The absorbate/sorbent (w/w) ratio can also be determined if complete wetting of the sorbent is achieved. The test consists of setting a transparent, open-ended cylinder filled with sorbent granules into a shallow container filled with test liquid. The wet front of test liquid is timed as it moves vertically upwards under the influence of capillary action.

The apparatus and reagents for the Van Trump method are as follows:
1. Transparent plastic tube, 100 mm long×31.5 mm I.D. with a 60 mesh metal screen attached to one end. The outer wall of the tube is marked in 1 cm increments up to 8 cm.
2. “U” shaped wire, 1 mm diameter, that can fit into the petri dish
3. Petri dish, 100 mm diameter or larger
4. Test liquid (record description and type)
5. Granular sorbent
6. Beaker, 200 mL
7. Balance, accurate to 0.01 grams
8. Stopwatch

The procedure for the Van Trump method are as follows:
1. Record the weight of the empty cylinder and attached screen (W).
2. Fill the cylinder with sorbent up to the 8 cm mark. Do not compact the material by tapping or applying pressure from the top. Weigh the cylinder with sorbent and record weight (W1).
3. Place “U” shaped wire in the bottom of the petri dish and fill it with test fluid up to the 6 mm level using a pre-drawn mark on the outer wall of the petri dish.
4. Pour about 100-150 mL of the test fluid into a 200 mL beaker and set aside.
5. With the stopwatch ready, place the cylinder with the sorbent on top of the “U” shaped wire in the bottom of the petri dish (see FIG. 1). Start the stopwatch immediately.
6. Record the height(a), in cm, reached by the fluid at 15 sec., 30 sec., 45 sec., 1 min., 2 min., 5 min., 10 min., 15 min., 30 min., 45 min., 1 hr., 2 hr., 4 hr., 6 hr. Important: the level of fluid in the petri dish must be kept constant throughout the test period. Add fluid from the beaker whenever the level drops below the 6 mm mark on the petri dish.
7. When the material is completely saturated (b) as determined by observing wet sorbent at the top of the tube, it should be left in the petri dish for an additional 15 minutes.
8. Remove the tube and carefully, but quickly, wipe excess fluid from the tube's outer wall and bottom screen. Do not blot the screen. Weigh and record weight (W₂).

The calcuations for the Van Trump method are as follows:
1. Weight of empty cylinder and attached screen, in grams W
2. Weight of cylinder with dry sorbent, in grams W₁
3. Weight of cylinder with soaked sorbent, in grams W₂
4. Absorbate/sorbent sorption ratio, (g/g)

$$S = \frac{\text{?} {W}_{2} - {W}_{1} \text{?}}{\text{?} {W}_{1} - W \text{?}}$$

$$\text{?} \text{indicates text missing or illegible when filed}$$

5. Sorption rate, wet front height (in cm) vs. time (in minutes) in table or graph form.

Experimental data was collected on the process of water adsorption on 5/20 LVM-MS red that supports the validity of the claim that traction granules generate heat through an exothermic reaction as they begin to absorb the melted ice.

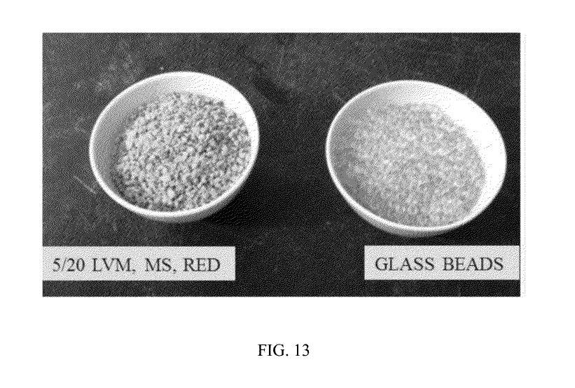

As shown in FIG. 13, two samples were used in the study. Sample 1 was 5/20 LVM-MS red and sample 2 was glass beads used as a non-porous reference sample. FIG. 13 depicts photographs of the two samples used in the study.

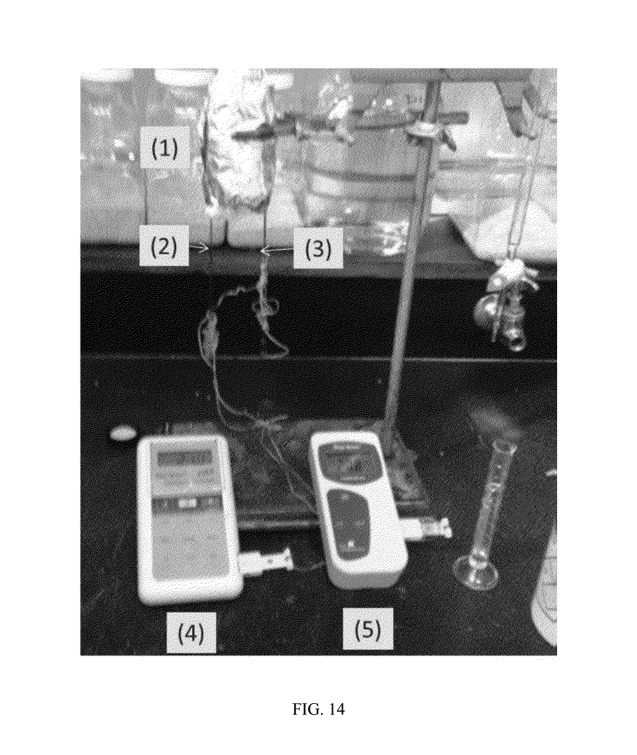

The heat of water adsorption was measured using the home-made calorimetric set up shown in FIG. 14. FIG. 14 depicts an experimental set up for heat of water adsorption measurement. (1) Insulated glass bottle containing clay or glass beads; (2) and (3) thermocouple probes; (4) and (5) temperature read outs.

In a typical experiment, 30 grams of the sample (clay or glass beads) was taken in a 120 mL capacity glass bottle. Two thermocouple probes (temperature monitors) were glued onto to the two lower opposite sides of the bottle which was then insulated with glass wool and wrapped with aluminum foil to prevent heat loss during adsorption. The bottle was clamped to a metal stand as shown in FIG. 14 and the two thermocouples connected to read out devices.

Aliquots of water (2 mL) were then added to the sample maintained under ambient condition and the temperature was noted down after 30 seconds of waiting period. Three data sets were collected for each sample.

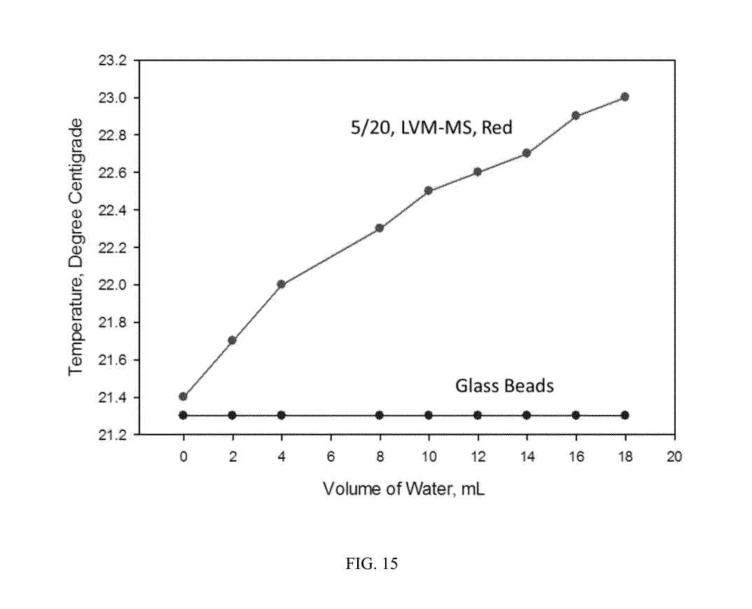

FIG. 15 shows a plot of sample temperature with the addition of water. As seen in the figure, the temperature of glass beads did not change upon addition of water. However, in the case of 5/20 LVM-MS red there was a rise in temperature by 1.6 degree centigrade in 18 minutes indicating exothermic nature of the adsorption process on the clay surface. Generally, clays are endowed with high surface area and porous structure. When water is adsorbed on the pore surfaces, heat is given out due to exothermic nature of the adsorption process. Glass beads on the other hand are non-porous and have very low surface area and pore volume compared to that of the clay. As such there will be a low degree of water adsorption and little rise in temperature upon water addition.

Applicants confirm the heat generation on the surface of the 5/20 LVM, MS red clay due to adsorption/sorption of water on the clay surface.

Although the present invention and its advantages have been described in detail, it should be understood that various changes, substitutions and alterations can be made herein without departing from the spirit and scope of the invention as defined in the appended claims.

The invention is further described by the following numbered paragraphs:
1. A dry composition for absorbing water created by ice melting comprising an absorbent constituent and a salt wherein the proportion amount ranges from about 90:10 wt % to about 10:90 wt %, wherein the absorbent constituent maintains its integrity upon wetting either naturally or through heat treatment.
2. The composition of paragraph 1 wherein the absorbent constituent has a liquid holding capacity which is at least 10%.
3. The composition of paragraph 1 or 2 wherein the absorbent constituent is a non-mineral absorbent material.
4. The composition of paragraph 1 or 2 wherein the absorbent constituent is a low moisture content clay.
5. The composition of any one of paragraphs 1, 2, or 4 wherein the absorbent constituent is a montmorillonite clay.
6. The composition of any one of paragraphs 1-5 further comprising the absorbent constituent changing to a dark color upon absorption of a liquid.
7. The composition of any one of paragraphs 1-6 wherein the absorbent constituent generates heat through adsorption of a liquid.
8. The composition of any one of paragraphs 1-7 wherein the absorbent constituent provides traction.
9. The composition of any one of paragraphs 1-8 wherein the absorbent constituent and the salt have a particle size in the range from 60 mesh to 4 mesh.
10. The composition of paragraph 9 wherein the absorbent constituent and the salt have a particle size in the range from 20 mesh to 4 mesh.
11. The composition of any one of paragraphs 1-10 wherein the absorbent constituent and the salt have a bulk density in the range from 15-90 lb/ft³.
12. The composition of any one of paragraphs 1 to 11 wherein the absorbent constituent is a brine impregnated clay.
13. The composition of paragraph 12 wherein the brine impregnated clay is an 80:20 clay:salt solution.
14. The composition of any one of paragraphs 1-13 wherein the salt is NaCl, CaCl₂, MgCl₂, K₂SO₄ and/or a mixture thereof.
15. The composition of paragraph 14 wherein the salt is NaCl.
16. The composition of any one of paragraphs 1-15 wherein the composition is a darker color upon water absorption.
17. The composition of paragraph 16 wherein the darker color accelerates heat treatment.
18. A method of manufacturing the composition of any one of paragraphs 1-15 comprising mixing the absorbent constituent and the salt to form a mixture and drying the mixture, thereby manufacturing the dry composition of any one of paragraphs 1-15.
19. A method for improving soil quality comprising adding the composition of any one of paragraphs 1-15 to soil.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A dry composition for absorbing water created by ice melting comprising an absorbent constituent and a salt wherein the proportion amount ranges from about 90:10 wt % to about 10:90 wt %, wherein the absorbent constituent maintains its integrity upon wetting either naturally or through heat treatment.

2. The composition of claim 1 wherein the absorbent constituent has a liquid holding capacity which is at least 10%.

3. The composition of claim 1 wherein the absorbent constituent is a non-mineral absorbent material.

4. The composition of claim 1 wherein the absorbent constituent is a low moisture content clay.

5. The composition of claim 1 wherein the absorbent constituent is a montmorillonite clay.

6. The composition of claim 1 further comprising the absorbent constituent changing to a dark color upon absorption of a liquid.

7. The composition of claim 1 wherein the absorbent constituent generates heat through adsorption of a liquid.

8. The composition of claim 1 wherein the absorbent constituent provides traction.

9. The composition of claim 1 wherein the absorbent constituent and the salt have a particle size in the range from 60 mesh to 4 mesh.

10. The composition of claim 9 wherein the absorbent constituent and the salt have a particle size in the range from 20 mesh to 4 mesh.

11. The composition of claim 1 wherein the absorbent constituent and the salt have a bulk density in the range from 15-90 lb/ft³.

12. The composition of claim 1 wherein the absorbent constituent is a brine impregnated clay.

13. The composition of claim 12 wherein the brine impregnated clay is an 80:20 clay:salt solution.

14. The composition of claim 1 wherein the salt is NaCl, CaCl₂, MgCl₂, K₂SO₄ and/or a mixture thereof.

15. The composition of claim 14 wherein the salt is NaCl.

16. The composition of claim 1 wherein the composition is a darker color upon water absorption.

17. The composition of claim 16 wherein the darker color accelerates heat treatment.

18. A method of manufacturing the composition of claim 1 comprising mixing the absorbent constituent and the salt to form a mixture and drying the mixture, thereby manufacturing the dry composition of claim 1.

19. A method for improving soil quality comprising adding the composition of claim 1 to soil.
